(19) United States
(12) Patent Application Publication
(10) Pub. No.: US 2013/0295796 A1
(43) Pub. Date: Nov. 7, 2013

(54) MULTIPLE PLUG CONNECTOR UNIT

(71) Applicant: Yazaki Corporation, Tokyo (JP)

(72) Inventors: Nobukazu KATO, Yokohama-shi (JP); Hidenobu TAKAHASHI, Yokohama-shi (JP); Kazukuni HISATOMI, Yokohama-shi (JP)

(21) Appl. No.: 13/861,111

(22) Filed: Apr. 11, 2013

Related U.S. Application Data
(63) Continuation of application No. 13/597,691, filed on Aug. 29, 2012, now abandoned.

(30) Foreign Application Priority Data
Aug. 29, 2011 (JP) 2011-186586

(51) Int. Cl. H01R 27/02

(52) U.S. Cl. CPC H01R 27/02
USPC 439/660

(57) ABSTRACT

A multiple plug connector unit 20 has a plurality of plugs 30, 40 each including a plurality of contacts 40K and an insulator 40Z holding the plurality of contacts, a board 50 having patterns 53 and 54 to be soldered to lower ends 30K3 and 40K3 of the plurality of contacts 30K and 40K of the respective plugs 30 and 40, and a case 60 that collectively accommodates the respective plugs 30 and 40 and has holes 63 and 64 formed for making only fitting sections of the respective plugs exposed. At least one of the plurality of plugs has a movable structure between the respective fitting sections and soldered portions.

### CROSS-REFERENCE TO RELATED APPLICATION

This is a continuation of application Ser. No. 13/597,691, filed Aug. 29, 2012, which claims priority from Japanese Patent Application No. 2011-186586, filed Aug. 29, 2011, which applications are incorporated herein in their entirety by reference.

### BACKGROUND

1. Field of the invention

The present invention relates to a multiple plug connector unit having two dissimilar plugs, like a micro USB plug and a Type D HDMI plug, or more. In particular, the present invention relates to a multiple plug connector unit that enables connection of plugs with their respective corresponding receptacles even when a small manufacturing error exists in a distance between the receptacles and, in addition, making of contribution to miniaturization.

2. Description of the related art

<Existing Connector Unit>

A known socket connector described in connection with; for instance, Patent Document 1, is equipped with a shielded housing having a plurality of side walls for defining receptacle slots and a main body having a plurality of connectors and a plurality of conductive contacts built in the respective connectors.

Further, in relation to a plurality of connectors, a connector unit made up of a micro USB plug 400 and a Type D HDMI plug, such as that shown in FIG. 11, has been commercially available.

FIG. 11 is a partially broken perspective view of an existing, known connector unit with two plugs.

In FIG. 11, a connector unit 200 with two plugs includes the micro USB plug 400 and the Type D HDMI plug 300. The micro USB plug is used for a personal computer, and the Type D HDMI plug is used for a digital TV, and others. Accordingly, when both the personal computer and the digital TV are simultaneously used while being connected to a smart phone, the micro USB plug 400 and the Type D HDMI plug 300 must be fitted to a micro USB receptacle and a Type D HDMI receptacle of the smart phone, respectively.

Incidentally, in a case where a small manufacturing error exists in distance between the respective receptacles, there may occur a case where two plugs cannot be simultaneously connected if they are completely fixed (digit).

In order to solve the problem, the connector unit 200 with two plugs shown in FIG. 11 has a cable 740 connected to the micro USB plug 400. Further, the micro USB plug 400 is fixed to a case by way of a cushioning material 400K fitted around the micro USB plug 400. A hole through which a fitting section of the micro USB plug 400 is exposed is slightly oversized.

The configuration makes the fitting section of the micro USB plug 400 movable to a certain extent. Even if small positional displacement exists when the micro USB plug 400 fits to its corresponding receptacle with the Type D HDMI plug 300 fitted to its corresponding receptacle, the micro USB plug 400 can fit to its corresponding receptacle by means of slightly moving itself.

As above, the connector unit with the two plugs shown in FIG. 11 can be connected to both receptacles without any problems even when a small manufacturing error exists in distance between both the corresponding receptacles.
Patent Document 1: JP-A-2011-3540

### <Drawbacks of the Existing Multiple Plug Connector Unit>

However, the multiple plug connector unit shown in FIG. 11 uses the cable. When the cable is routed in a direction orthogonal to the fitting direction, the cable cannot make a right-angled bend and eventually comes to make a widely curved bend. Therefore, a plug depth T20 (FIG. 11) achieved in the fitting direction becomes large, which raises a problem of difficulty to fulfill a need for miniaturization.

In particular, increased miniaturization has been persistently pursued in a market for portable devices like smart phones, the hitherto known existing multiple plug connector unit has raised problems in view of miniaturization.

### SUMMARY OF THE INVENTION

The present invention has been conceived to solve the drawbacks and aims at providing a multiple plug connector unit that enables lessening of a plug depth in a fitting direction and that enables fitting of a micro USB plug to a corresponding receptacle with a Type D HDMI plug remaining fitted to a corresponding receptacle even when small positional displacement exists in the receptacle of the micro USB plug.

The present invention has been conceived to solve the drawbacks, and the inventions (1) to (6) of the present application are characterized as follows:

(1) A multiple plug connector unit has a plurality of plugs each including a plurality of contacts and an insulator holding the plurality of contacts, a board to which the respective plugs are soldered at soldered portions, and a case that collectively accommodates the respective plugs and has holes for exposing fitting sections of the respective plugs. In the multiple plug connector unit, at least one of the plurality of plugs has a movable structure between the respective fitting sections and the respective soldered portions.

(2) The board is equipped with patterns to be connected with a plurality of cables by a solder or a connector.

(3) The fitting section of at least one plug of the plurality of plugs is fitted to a fitting section of a receptacle of a micro USB connector.

(4) The fitting section of at least one plug of the plurality of plugs is fitted to a fitting section of a receptacle of a Type D HDMI connector.

(5) The fitting section of at least one plug of the plurality of plugs is fitted to a fitting section of a receptacle of a micro USB connector, and the fitting section of at least another plug fits to a fitting section of a receptacle of a Type D HDMI connector.

(6) The plurality of cables correspond to at least one of a cable for transmitting a micro USB signal and a cable for transmitting a Type D HDMI signal.

By means of the configuration described in connection with (1), at least one plug has a movable structure between each of the fitting section and the soldered portion. Hence, even when a slight positional displacement exists in the corresponding receptacle, the plug can smoothly fit to the corresponding receptacle.

By means of the configuration described in connection with (2), since the board is equipped with the patterns that enable connection of a plurality of cables by way of solder or the connectors, a necessity to route the cables in a direction orthogonal to the fitting direction becomes obviated, and contribution to miniaturization can be made.

By means of the configurations described in connection with (3) to (6), the multiple plug connector unit can fit to the micro USB connector and the Type D HDMI connector, to thus enable performance of transmission at respective signals. Demands in the market of portable devices, such as smart phones, can be satisfied.

### BRIEF DESCRIPTION OF THE DRAWINGS

FIG. 1A is a front view of a cable using a multiple plug connector unit of the present invention, and FIG. 1B is a plan view of the same;

FIG. 2A is a plan view of a board used for the multiple plug connector unit of the present invention, and FIG. 2B is a front cross sectional view of the multiple plug connector unit taken along a longitudinal cross sectional plane passing through the center of plugs;

FIG. 3A is an enlarged perspective view of the multiple plug connector unit, FIG. 3B is a perspective view of a case for housing a plurality of plugs when viewed from behind, and FIG. 3C is a perspective view of the multiple plug connector unit shown in FIG. 3A when viewed from the back;

FIG. 4A is a plan view of a micro USB plug, FIG. 4B is a front view of the same, and FIG. 4C is a perspective view of the same;

FIG. 5A is a perspective view showing a base shell of the micro USB plug in a partially broken manner, FIG. 5B is a perspective view showing a fitting section shell of the micro USB plug in a partially broken manner, and FIG. 5C is a perspective view of the fitting section shell of the micro USB plug;

FIG. 6A is a cross section when viewed in the direction of arrows A-A shown in FIG. 4A, and FIG. 6B is a cross section when viewed in the direction of arrows B-B shown in FIG. 4B;

FIGS. 7A to 7G are perspective views showing a first half of processes of assembling the micro USB plug;

FIGS. 8A to 8D are perspective views showing a last half of the process of assembling the micro USB plug;

FIGS. 9A to 9C are perspective views showing a process of assembling a Type D HDMI plug;

FIG. 10A is a front cross sectional view of the Type D HDMI plug, and FIG. 10B is a side cross sectional view of the same; and

FIG. 11 is a partially broken perspective view of a known, existing connector unit with two plugs.

### DESCRIPTION OF THE PREFERRED EMBODIMENTS

By reference to the accompanying drawings, explanations are hereunder given to a multiple plug connector unit that enables smooth fitting of a plug to its corresponding receptacle even when small positional displacement exists in the receptacle and that also makes contribution to miniaturization.

### <Grounds for a Reduction in Plug Depth Achieved Under the Present Invention>

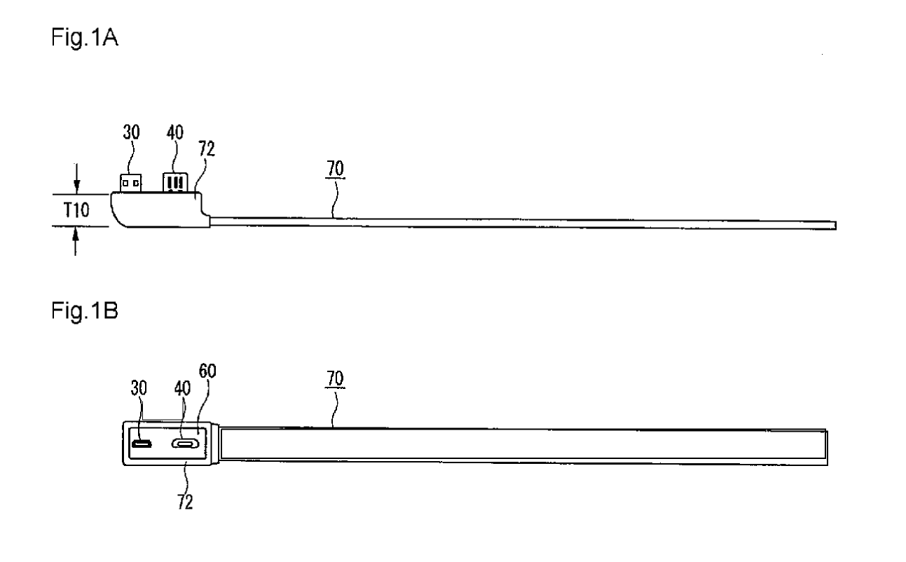

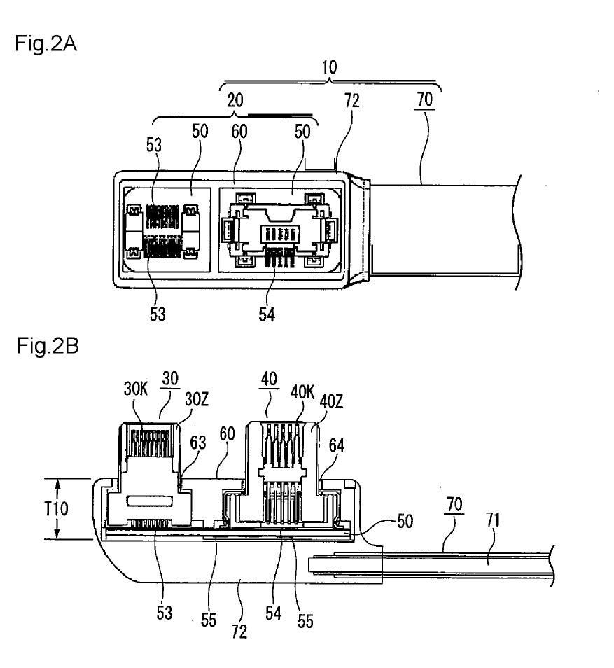

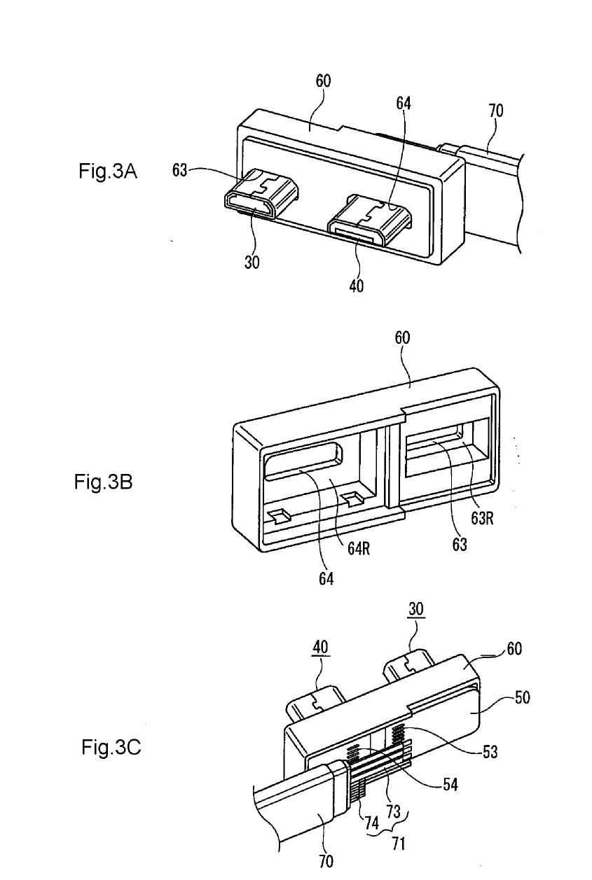

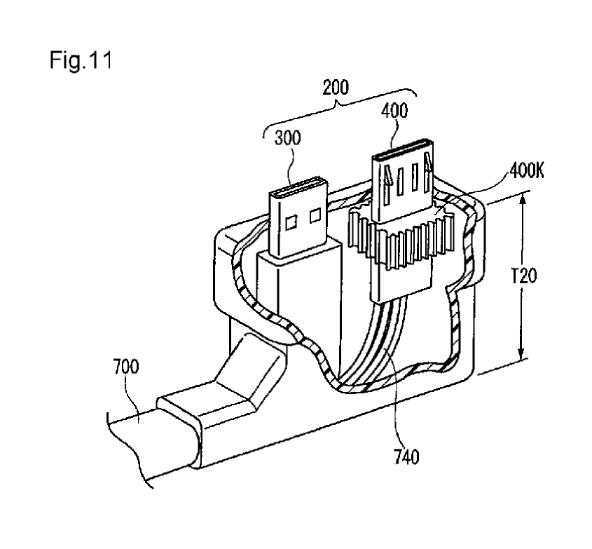

FIG. 1 is a view for explaining a cable using a multiple plug connector unit of the present invention. The multiple plug connector unit has a Type D HDMI plug 30 and a micro USB plug 40. The plugs are housed in a housing 72 and connected to a cable 70. The multiple plug connector unit shown in FIG. 1 is a miniaturized multiple plug connector unit whose plug depth T10 achieved in a fitting direction becomes smaller than that of the commercially available multiple plug connector unit shown in FIG. 11. By reference to FIGS. 2 and 3, explanations are given to grounds that the plug depth of the multiple plug connector unit of the present invention is reduced as above.

FIG. 2A is a plan view of a board used for the multiple plug connector unit of the present invention, and FIG. 2B is a front cross sectional view of the multiple plug connector unit taken along a longitudinal cross sectional plane passing through the center of plugs. A cable 10 using the multiple plug connector unit of the present invention is implemented by attaching the cable 70 to a multiple plug connector unit 20 of the present invention. The multiple plug connector unit 20 is made up by housing in a case 60 the Type D HDMI plug 30, the micro USB plug 40, and a board 50, wherein the board 50 has a pattern 53 to be soldered to a contact 30K of the plug 30 and a pattern 54 to be soldered to a contact 40K of the plug 40.

The cable 70 is made up of a variety of electric wires 71 connected to a pattern on the back of the board 50 by soldering and the housing 72 housing the case 60.

The board 50 shown in FIG. 2A has the pattern 53 for the Type D HDMI plug 30 and the pattern 54 for the micro USB plug 40. The respective patterns 53 and 54 extend from the front to the back (see FIG. 3C) of the board 50 while passing through the same. FIG. 3C is a perspective view of the multiple plug connector unit shown in FIG. 3A when viewed from behind. The respective patterns 53 and 54 extended to the back of the board 50 while passing through the same are electrically connected to an HDMI signal wire 73 and a USB signal wire 74 of the cable 70 by means of soldering.

Although the patterns 53 and 54 are electrically connected to the HDMI signal wire 73 and the USB signal wire 74 of the cable 70 by means of soldering, the present invention is not limited to soldering. As a matter of course, in addition to an electric connection implemented by soldering, another electric connection implemented by way of a connector can also be established between the signal lines.

As can be seen from the respective electric connections between the patterns 53, 54 and the various signal wires 73, 74 shown in FIG. 3C, the electric wires 71 extend sideways directly to a position above the respective patterns 53 and 54 of the board 50. In contrast with the case shown in FIG. 11, the cable 70 does not make a wide curve, and hence the plug depth T10 (FIGS. 1A and 2B) achieved in a fitting direction can be made small, and the connector unit will be useful in the market of mobile devices, like smart phones, that persistently pursue increased miniaturization.

### <The Plug can Fit to the Corresponding Receptacle Involving Positional Displacement>

Explanations are now given to a movable structure that enables smooth fitting of the micro USB plug 40 to its corresponding receptacle even when small positional displacement exists in the receptacle.

### <Multiple Plug Connector Unit 20>

FIG. 3A is an enlarged perspective view of the multiple plug connector unit. In FIG. 3A, a fitting section of the Type D HDMI plug 30 is exposed through a hole 63 of the case 60, and a fitting section of the micro USB plug 40 is exposed through a hole 64 of the case 60. At this time, the hole 64 for the micro USB plug 40 is slightly larger such that small clearance exists between a circumference of the fitting section of the micro USB plug 40 and the hole 64.

On the contrary, the fitting portion of the hole 63 for the Type D HDMI plug 30 is exposed in such a way that no clearance exists between the hole 63 for the Type D HDMI plug 30 and the Type D HDMI plug 30.

FIG. 3B is a perspective view of a case for housing a plurality of plugs shown in FIG. 3A when viewed from the back of the case. A chamber 63R for accommodating the Type D HDMI plug 30 and a chamber 64R for accommodating the micro USB plug 40 are formed in the case 60 molded from a resin. The hole 63 through which the fitting section of the Type D HDMI plug 30 becomes exposed is formed in a top of the chamber 63R, and the hole 64 through which the fitting section of the micro USB plug 40 becomes exposed is formed in a top of the chamber 64R.

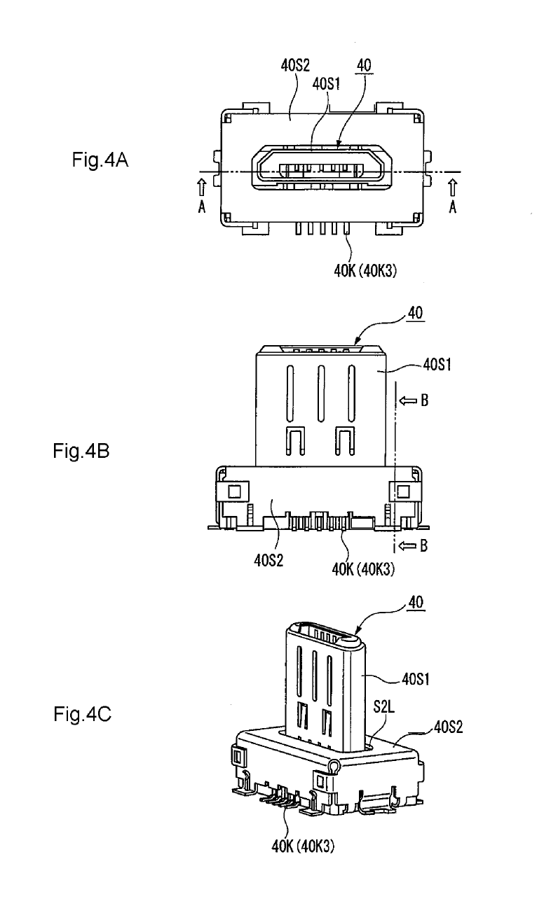

FIG. 4A is a plan view of the micro USB plug, FIG. 4B is a front view of the same, and FIG. 4C is a perspective view of the same. The micro USB plug 40 has a fitting section shell 40S1 that forms a fitting section and a base shell 40S2 disposed outermost for covering the board, thereby providing an electrical shield for all signals.

Fixing insulator for fixing five contacts 40K is housed in the fitting section shell 40S1. Lower ends 40K3 of the five contacts 40K project outside from below a skirt of the base shell 40S2 and are soldered to the pattern 54 of the board 50 (FIG. 2B).

An opening S2L (FIG. 4C) through which the fitting section shell 40S1 penetrates is formed in a top of the base shell 40S2, and the fitting section shell 40S1 becomes exposed through the opening S2L.

The fitting section shell 40S1 and the base shell 40S2 are electrically connected together as will be described later. The fitting section shell 40S1 and the base shell 40S2 are movable rather than being completely fixed in a mechanical sense.

### <Structure of the Micro USB Plug 40>

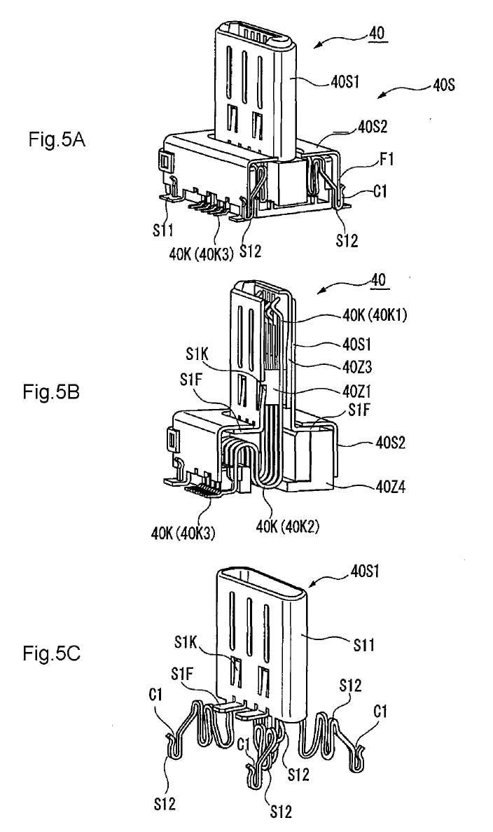

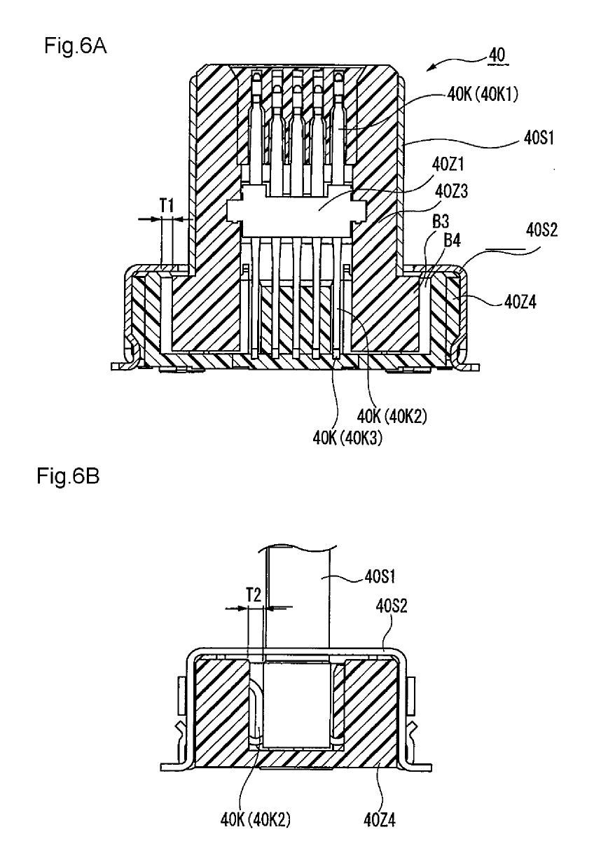

FIG. 5A is a perspective view showing the base shell of the micro USB plug in a partially broken manner; FIG. 5B is a perspective view showing the fitting section shell of the micro USB plug in a partially broken manner; FIG. 5C is a perspective view of the fitting section shell of the micro USB plug; FIG. 6A is a cross section when viewed in the direction of arrows A-A shown in FIG. 4A; and FIG. 6B is a cross section when viewed in the direction of arrows B-B shown in FIG. 4B.

The micro USB plug 40 is made up of the five contacts 40K, insulators 40Z, and shells 40S.

### <Insulators 40Z>

The insulators 40Z are made up of a fixing insulator 40Z1, a fitting insulator 40Z3, a base insulator 40Z4, and a fixing insulator 40Z5.

### <Fitting Insulator 40Z3>

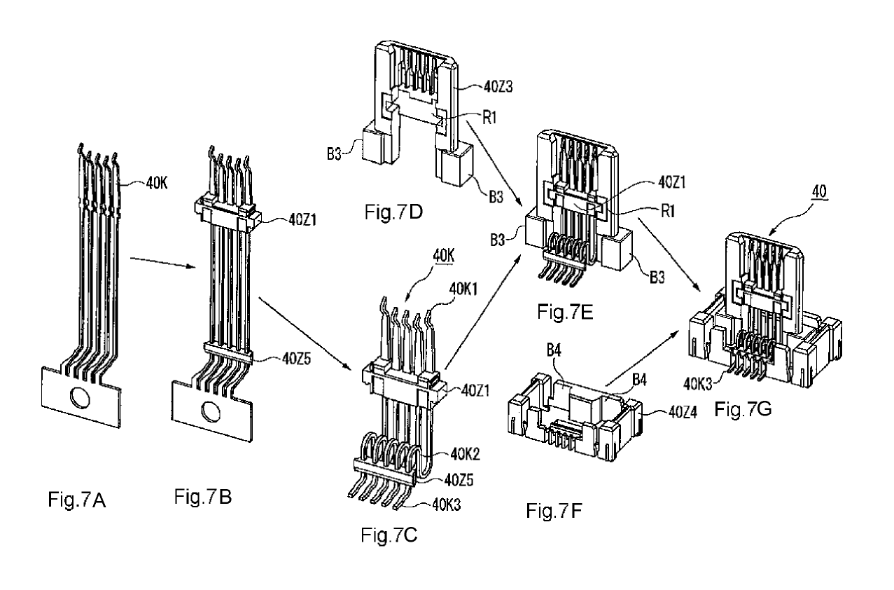

The fitting insulator 40Z3 (FIG. 6A and FIG. 7D) is an enclosure formed from an insulating resin and houses in its center the fixing insulator 40Z1 (FIGS. 6A and FIG. 7C) for fixing the five contacts 40K by means of a mold. Bulges B3 are outwardly formed on both sides of a lower portion of the enclosure. As a result of the bulges B3 being accommodated in respective fitting insulator accommodation portions B4 (FIG. 6A and FIG. 7F) formed in the base insulator 40Z4, the entire insulators 40Z are completed.

### <Five Contacts 40K>

The five contacts 40K (FIG. 5B and FIG. 7C) are areas where upper leading ends 40K1 contact their corresponding receptacles; where intermediate portions 40K2 are bent into an S-shaped form and imparted with resilience; and the lower ends 40K3 are soldered (FIG. 2B) to the pattern 54 of the board 50 (FIG. 2A).

In FIG. 5B, long five contacts 40K are housed in internal space formed from the fitting insulator 40Z3 and the base insulator 40Z4 (see FIG. 7E).

Even when the lower ends 40K3 are fixed to the board 50, the upper leading ends 40K1 can move in both the vertical direction and the horizontal direction within a horizontal plane by means of the intermediate portions 40K2 that make an S-shaped bend to thereby exhibit resilience. Accordingly, the micro USB plug 40 can move between the area where the micro USB plug 40 is soldered to the board 50 and each of the fitting sections (the fitting insulator 40Z3).

Although the intermediate portions 40K2 are given an S-shaped bend, to thus exhibit resilience, the present invention is not limited to the S-shaped bend. In addition to the S-shaped bend, another bend, like an L-shaped bend, a U-shaped bend, and a W-shaped bend, or a bend made by repeating any of the bends a number of times can also be employed to cause the intermediate portions 40K2 to exhibit resilience.

### <Shell 40S>

The shell 40S (FIG. 5A) effects an electrical shield and is accordingly formed from a thin metallic plate. The shell 40S is made up of the fitting section shell 40S1 making the fitting section of the plug and the base shell 40S2 covering the board.

### <Fitting Section Shell 40S1>

The fitting section shell 40S1 is made up of a fitting section S11 (FIG. 5C) exposed through the opening S2L (FIG. 4C) of the base shell 40S2 and resilient connecting portions S12 (FIG. 5C) that downwardly extend from a lower area of each of flats of the fitting section S11.

<Fitting section S11>

The fitting section S11 assumes a shape made by flattening a hollow cylindrical, thin metallic plate from both sides. The fitting insulator 40Z3 (FIG. 5B, FIG. 6A) housing the five contacts 40K (FIG. 5B and FIG. 6A) is accommodated in the fitting section S11. Engagement pieces S1K that engage with respective grooves of the fitting insulator 40Z3 are formed at a plurality of locations within a flat of the fitting section S11. Leg pieces S1F (FIG. 5B) that are seated below the base shell 40S2 (FIG. 5B) to thus let the base shell 40S2 stably stand upright are formed at four locations on lower portions of the fitting section S11 (two on each of lower portions of the flats).

### <Resilient Connecting Portions S12>

The resilient connecting portions S12 (FIG. 5C) are elongated metallic bodies that each have downward S-shaped meanders from a total of four locations on lower areas of both flats of the fitting section S11. An upwardly-oriented U-shaped clip C1 is formed at each of leading ends of the respective elongated metallic bodies. Each of the four clips C1 is engaged with a skirt F1 (FIG. 5A) of the base shell 40S2 while the fitting section shell 40S1 remains fitted to the base shell 40S2, thereby letting the fitting section shell 40S1 stably stand upright so as to be able to move within the base shell 40S2 and establishing electrical connection between the fitting section shell 40S1 and the base shell 40S2.

### <Assembly Sequence of the Micro USB Plug>

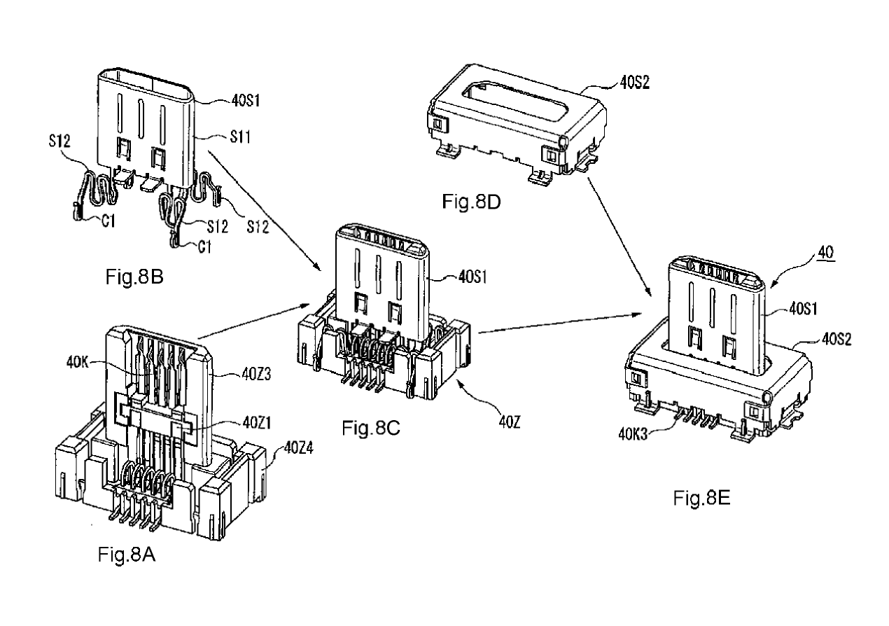

By reference to FIGS. 7A to 7G and FIGS. 8A to 8D, explanations are given to a sequence in which the micro USB plug is assembled by use of the aforementioned components. FIGS. 7A to 7G and FIGS. 8A to 8D are perspective views of processes for assembling a micro USB plug, wherein FIGS. 7A to 7G show a first half of the processes, and FIGS. 8A to 8D show a last half of the same.

First, in FIG. 7A, the five contacts 40K that will be elongated materials are punched from one thin metal plate, and the thus-punched five contacts are then pressed.

In FIG. 7B, two areas; namely, an upper area and a lower area, of the five contacts 40K are fastened by means of molding and with use of the fixing insulators 40Z1 and 40Z5.

In FIG. 7C, areas in the vicinity of the fixing insulator 40Z5 between the fixing insulators 40Z1 and 40Z5 of the five contacts 40K are formed into the shape of letter S.

In FIG. 7D, the fitting insulator 40Z3 is additionally formed. A fixing insulator accommodation chamber R1 for accommodating the entirety of the fixing insulator 40Z1 is formed in the fitting insulator 40Z3.

In FIG. 7E, the fixing insulator 40Z1 bundling and fixing the five contacts 40K that are formed into the shape of letter S is fitted and thereby fixed to the fixing insulator accommodation chamber R1 of the fitting insulator 40Z3.

In FIG. 7F, the base insulator 40Z4 is additionally formed. The fitting insulator accommodation portions B4 are formed in the substantial center of the base insulator 40Z4.

In FIG. 7G, the bulges B3 (FIG. 7E) formed at the lower portion of the fitting insulator 40Z3 are fitted into the respective fitting insulator accommodation portions B4 (FIG. 7F) of the base insulator 40Z4, thereby completing the insulator 40Z. Leading ends 40K3 of the five contacts 40K are exposed outside from the lower portion of the insulator 40Z.

In FIG. 8A, the fitting section shell 40S1 is subjected to press-working. The fitting section shell 40S1 is made up of the fitting section S11 and the resilient connecting portion S12. The U-shaped clip Cl is formed at a leading end of the resilient connecting portion S12.

In FIG. 8B, the thus-pressed fitting section shell 40S1 is assembled into the contact-equipped insulator 40Z.

In FIG. 8C, the base shell 40S2 is subjected to press-working.

In FIG. 8D, the pressed base shell 40S2 is fitted into the contact-equipped insulator 40Z from above. The four clips C1 of the resilient connecting portions S12 of the fitting section shell 40S1 are caused to nip the skirt of the base shell 40S2, whereby electrical and mechanical connections are established between the fitting section shell 40S1 and the base shell 40S2. Thus, the micro USB plug 40 is completed. By virtue of presence of the resilient connecting portions S12, the fitting section shell 40S1 can slightly move in both the vertical and horizontal directions in the base shell 40S2.

In FIG. 6, the distance over which the fitting section shell 40S1 becomes movable in its widthwise direction is designated by T1, and a distance over which the fitting section shell 40S1 can move in its thicknesswise direction is designated by T2.

In the next step, the micro USB plug 40 is accommodated into the accommodation chamber 64R of the micro USB plug 40 in the case 60 (FIG. 3B), and the Type D HDMI plug 30 to be described later is accommodated into the accommodation chamber 63R of the Type D HDMI plug 30 in the case 60. The case 60 is covered with the board 50 having the patterns 53 and 54 while lower ends 30K3 of the contacts of the Type D HDMI plug 30 are soldered with the pattern 53 and while the lower ends 40K3 of the contacts of the micro USB plug 40 are soldered to the pattern 54. The HDMI signal wire 73 of the cable 70 is soldered to the pattern 53 (FIG. 3C), and the USB signal wire 74 of the cable 70 is soldered to the pattern 54 (FIG. 3C). The thus-soldered portions are covered with the housing 72 (FIG. 2B), thereby completing the cable 10 (FIG. 1) using the multiple plug connector unit.

### <Movable Structure of the Type D HDMI Plug>

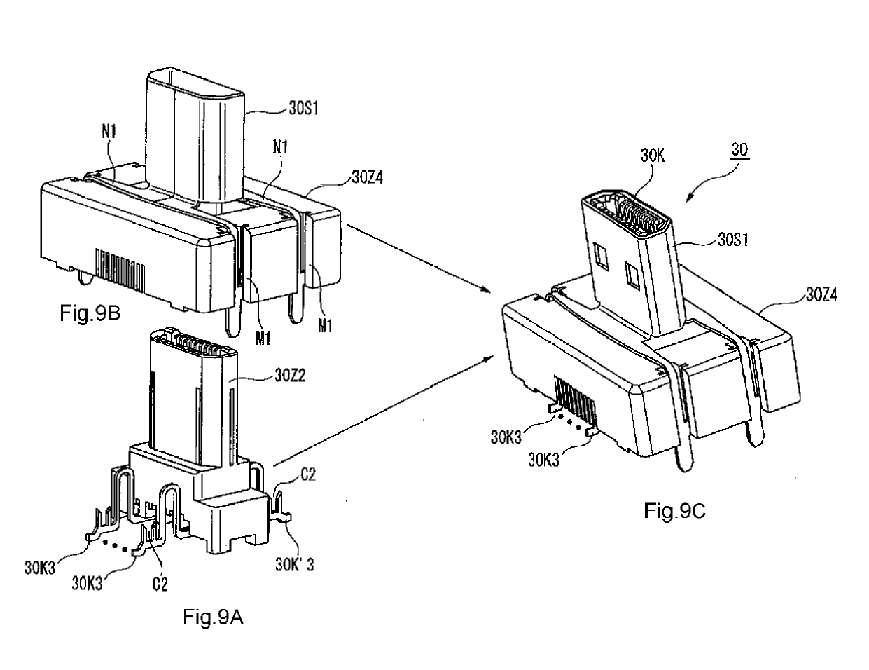

By reference to FIG. 9, explanations are now given to the fact that the Type D HDMI plug also has a movable structure as does the micro USB plug 40.

FIGS. 9A to 9C are perspective views showing a process of assembling the Type D HDMI plug.

In FIG. 9A, the plurality of S-formed contacts 30K are arranged side by side in a horizontal row within a fitting insulator 30Z3. Likewise, a plurality of S-formed contacts 30K′ are accommodated within the fitting insulator 30Z3 while standing along with the contacts 30K back to back in a horizontal row.

The respective contacts 30K and 30K′ are in principle identical with the contacts 40K of the micro USB plug 40 in terms of a material, a function, and a shape. Specifically, upward leading ends of the contacts 30K and 30K′ are area to contact their respective receptacles. Intermediate portions of the respective contacts have an S-shaped bend, to thus exhibit resilience, so that the respective contacts 30K and 30K′ are made slightly movable. Clips C2 formed upwardly in the form of the letter U are formed in the vicinity of the lower ends of the contacts 30K to thereby be able to clip a skirt of a base insulator 30Z4.

In FIG. 9B, strip-shaped portions N1 horizontally extending from a lower end of a fitting section shell 30S1 are fitted into respective grooves M1 formed in the base insulator 30Z4, thereby fixing the fitting section shell 30S1 upright on the base insulator 30Z4.

The grooves M1 and the strip-shaped portions N1 are loosely fitted together, so that the fitting section shell 30S1 is slightly movable in the vertical and horizontal directions within a horizontal plane with respect to the base insulator 30Z4.

In FIG. 9C, the base insulator 30Z4 assembled in the process shown in FIG. 9B is fitted onto the contact-equipped fitting insulator 30Z3 assembled in the process shown in FIG. 9A. Further, the clips C2 of the respective contacts 30K and 30K′ clip the skirt of the base insulator 30Z4, whereby there is completed a Type D HDMI plug in which the fitting insulator 30Z3 having the contacts 30K and 30K′ and the base insulator 30Z4 are mechanically fastened together. By means of the S-formed contacts 30K and 30K′, the Type D HDMI plug is configured such that the fitting section shell 40S1 becomes slightly movable in both the vertical and horizontal directions within the base shell 40S2.

In the next step, the Type D HDMI plug 30 is accommodated in the case 60 (FIG. 3B) as is the micro USB plug 40. The cable 10 (FIG. 1) using the multiple plug connector unit is thus completed through processing pertaining to the steps.

### <Structure of the Type D HDMI Plug>

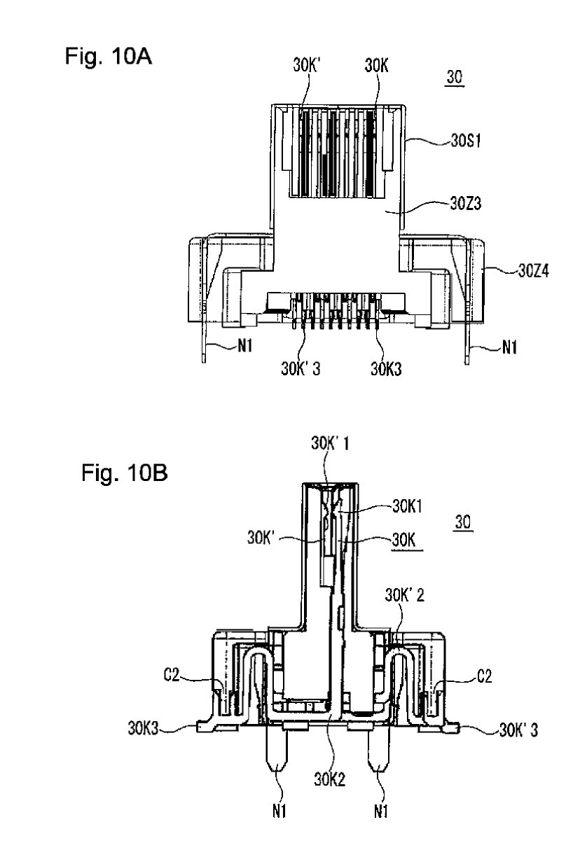

FIG. 10A is a front view of the Type D HDMI plug, and FIG. 10B is a side view of the same. The contacts 30K and the contacts 30K′ are accommodated back-to-back within the fitting insulator 30Z3. The clips C2 formed upwardly in the shape of letter U are provided in the vicinity of the lower ends 30K3 of the contacts 30K and 30K′, and the clips C2 clip the skirt of the base insulator 30Z4 (FIG. 10B).

The respective lower ends 30K3 of the contacts 30K and 30K′ downwardly project and are soldered to the patterns 53 shown in FIG. 2A, whereby the contacts 30K and 30K′ are electrically connected to the respective patterns 53.

### SUMMARY

(1) As above, according to the present invention, the plug has the movable structure interposed between the respective fitting sections and the soldered portions. Hence, even when a slight positional displacement exists in a corresponding receptacle, the plug can smoothly fit into the corresponding receptacle.

(2) Since the board is provided with the patterns that enable soldering-connection of a plurality of cables, a necessity to route the cable in a direction perpendicular to the fitting direction becomes obviated, so that the present invention can contribute to miniaturization of the connector unit.

(3) Therefore, the connector unit can fit to the micro USB connector and the Type D HDMI connector, to thus enable transmission of respective signals. Thus, demands in the market of portable devices, like smart phones, can be satisfied.

This application is based upon and claims the benefit of priority of Japanese Patent Application No. 2011-186586 filed on Aug. 29, 2011, the contents of which are incorporated herein by reference.

What is claimed is:

1. A multiple plug connector unit, comprising:
a plurality of plugs each including a plurality of contacts and an insulator holding the plurality of contacts;
a board to which the respective plugs are soldered at soldered portions; and
a case that collectively accommodates the respective plugs and has holes for exposing fitting sections of the respective plugs;
wherein at least one of the plurality of plugs has a movable structure between the respective fitting sections and the respective soldered portions.

2. The multiple plug connector unit according to claim 1, wherein the board is equipped with patterns to be connected with a plurality of cables by a solder or a connector.

3. The multiple plug connector unit according to claim 2, wherein the fitting section of at least one plug of the plurality of plugs is to be fitted to a fitting section of a receptacle of a micro USB connector.

4. The multiple plug connector unit according to claim 2, wherein the fitting section of at least one plug of the plurality of plugs is to be fitted to a fitting section of a receptacle of a Type D HDMI connector.

5. The multiple plug connector unit according to claim 2, wherein the fitting section of at least one plug of the plurality of plugs is to be fitted to a fitting section of a receptacle of a micro USB connector, and the fitting section of at least another plug is to be fitted to a fitting section of a receptacle of a Type D HDMI connector.

6. The multiple plug connector unit according to claim 2, wherein the plurality of cables correspond to at least one of a cable for transmitting a micro USB signal and a cable for transmitting a Type D HDMI signal.
